(19) United States
(12) Patent Application Publication
(10) Pub. No.: US 2026/0298311 A1
(43) Pub. Date: Oct. 1, 2026

(54) CABLE RETENTION AND TENSIONING MECHANISM

(71) Applicant: Doable Brands LLC, Plymouth, MN (US)

(72) Inventor: Brian G. Jacobson, Plymouth, MN (US)

(21) Appl. No.: 19/097,044

(22) Filed: Apr. 1, 2025

(51) Int. Cl. F16G 11/04; F16G 11/02; F16G 11/12

(52) U.S. Cl. CPC F16G 11/048; F16G 11/025; F16G 11/12

(57) ABSTRACT

Devices, systems, and mechanisms for a cable retention and tensioning mechanism are described herein. In some examples, one or more embodiments include a housing having an inner surface defining an opening partially through the housing, a carrier body shaped to be received by the opening partially through the housing, where the carrier body includes a first opening through the carrier body having a tapered cross-section and a threaded second opening through the carrier body having a threaded inner surface interfaced with a threaded tensioning rod, locking jaws shaped to be received by the first opening through the carrier body, and a retention cap configured to bias the carrier body including the locking jaws and the threaded tensioning rod in the housing, where the locking jaws are to retain a cable and the threaded tensioning rod is configured to tension the cable.

### TECHNICAL FIELD

The present disclosure relates to devices, systems, and methods for a cable retention and tensioning mechanism.

### Background

Cable deck railings can be a sleek, modern aesthetic that complements various architectural styles. Cable railing systems can use horizontal or vertical cables, often in combination with posts and handrails to provide a barrier that maintains safety while minimizing the visual impact non-cable railings can have on scenic views.

### BRIEF DESCRIPTION OF THE DRAWINGS

FIG. 1 illustrates an exploded perspective view of an example of a cable retention and tensioning mechanism in accordance with one or more embodiments.

FIG. 2A illustrates a side-section view of an example of a cable retention and tensioning mechanism having locking jaws in a first position in accordance with one or more embodiments.

FIG. 2B illustrates a side-section view of an example of a cable retention and tensioning mechanism having locking jaws in a second position while receiving a cable in accordance with one or more embodiments.

FIG. 2C illustrates a side-section view of an example of a cable retention and tensioning mechanism having locking jaws in the first position while retaining a cable in accordance with one or more embodiments.

FIG. 3 illustrates a side-section view of an example of a tensioning rod being rotated while a carrier body resists rotation located inside a housing of a cable retention and tensioning mechanism in accordance with one or more embodiments.

FIG. 4A illustrates a side-section view of an example of a cable retention and tensioning mechanism having locking jaws in the first position while retaining a cable and the tensioning rod being rotated in accordance with one or more embodiments.

FIG. 4B illustrates a side-section view of an example of a cable retention and tensioning mechanism having locking jaws in the first position while retaining a cable and the tensioning rod having caused a carrier body to translate to tension the cable in accordance with one or more embodiments.

### DETAILED DESCRIPTION

Devices, systems, and mechanisms for a cable retention and tensioning mechanism are described herein. In some examples, one or more embodiments include a housing having an inner surface defining an opening partially through the housing, a carrier body shaped to be received by the opening partially through the housing, where the carrier body includes a first opening through the carrier body having a tapered cross-section and a threaded second opening through the carrier body having a threaded inner surface interfaced with a threaded tensioning rod, locking jaws shaped to be received by the first opening through the carrier body, and a retention cap configured to bias the carrier body including the locking jaws and the threaded tensioning rod in the housing, where the locking jaws are to retain a cable and the threaded tensioning rod is configured to tension the cable.

As mentioned above, cable railings can be utilized on decks to provide a safety barrier while also maintaining visibility. For example, cable railings are typically smaller than non-cable railings, allowing for the preservation of scenic views and relatively unobstructed panoramas from decks, balconies, and staircases as compared with non-cable railings. This visibility is especially appealing in structures with scenic landscapes, where non-cable railing options can partially block these views. Additionally, the minimalism of cable railings can provide a particular aesthetic look. For example, cable railings can match well with modern and contemporary architectural styles, providing a clean, unobtrusive look.

Additionally, many cable railings are made of stainless steel. The use of stainless steel cables can make the cable railings strong, durable, and highly resistant to weather elements.

However, traditional installation methods for cable railings typically require multiple installation tools, or at least the use of two hands by an installer. For example, once a cable is run, an installer has to hold the cable, or a fitting attached to the cable, using one hand, and utilize another tool to articulate a tensioning mechanism with the other. Proper tension in the cable can ensure the cables are safe and do not sag. However, getting the cable to the proper tension can be difficult using traditional approaches.

A cable retention and tensioning mechanism according to the disclosure can allow for a cable to be provided to locking jaws and then tensioned using a single tool. For example, locking jaws can retain the cable, and a tensioning rod can be rotated to tension the cable. Such a cable retention and tensioning mechanism can allow for easier, faster, and more efficient installation of cable railings, as compared with previous approaches.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

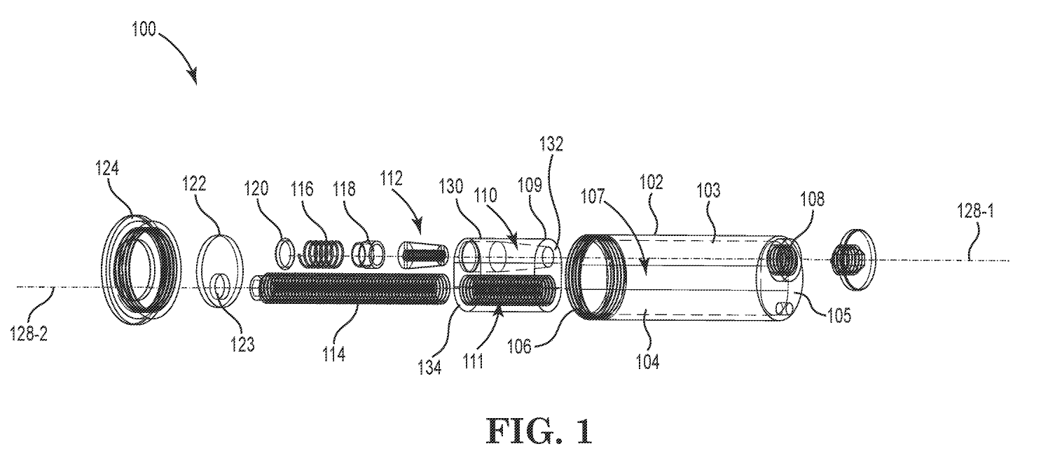

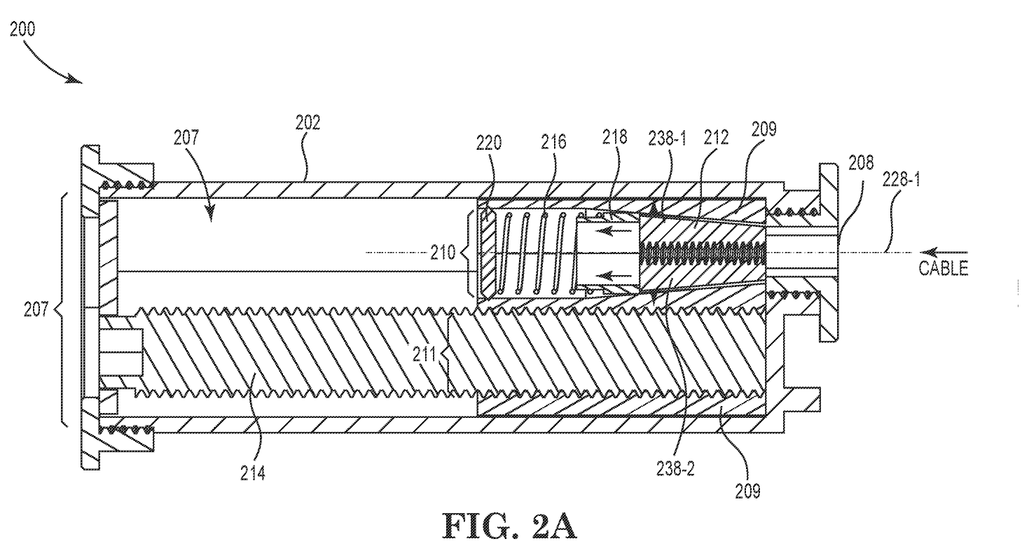

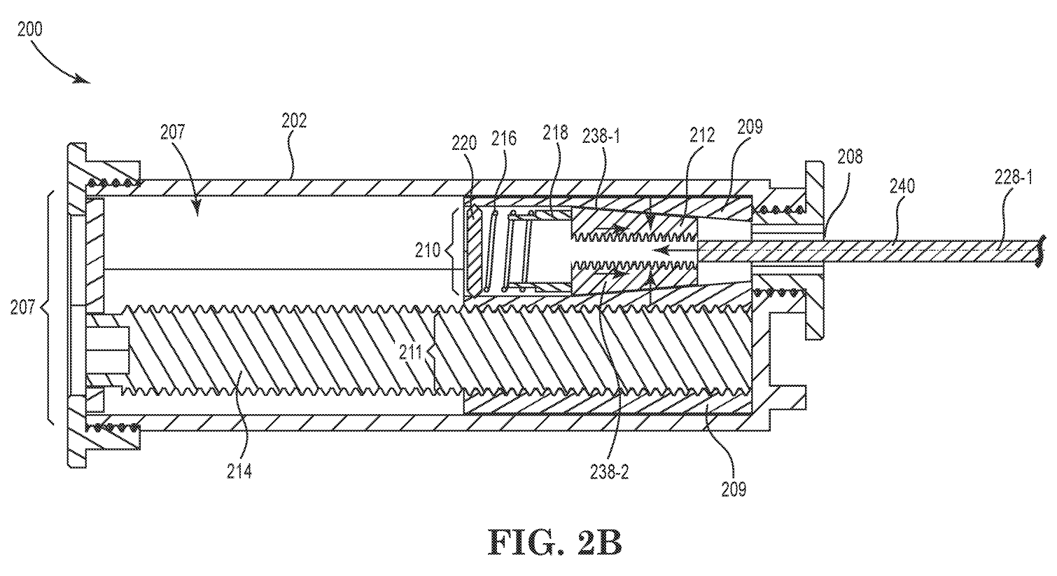

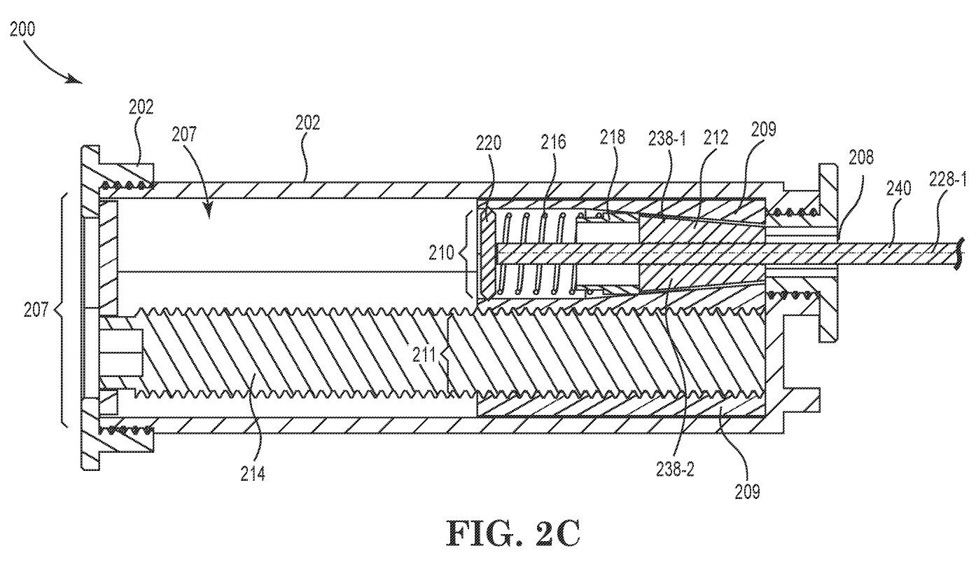

The figures herein follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2.

As used herein, “a”, “an”, or “a number of” something can refer to one or more such things, while “a plurality of” something can refer to more than one such things. For example, “a number of components” can refer to one or more components, while “a plurality of components” can refer to more than one component.

FIG. 1 illustrates an exploded perspective view of an example of a cable retention and tensioning mechanism 100 in accordance with one or more embodiments. As illustrated in FIG. 1, the cable retention and tensioning mechanism 100 can include a housing 102, a carrier body 109, locking jaws 112, and a retention cap 124.

As mentioned above, a cable retention and tensioning mechanism 100 can be utilized to retain and tension a cable. The cable can be tensioned in order to safely provide a barrier on a deck or other installation. The cable retention and tensioning mechanism 100 can utilize the locking jaws 112 and a threaded tensioning rod 114 to easily and efficiently retain and tension a cable, as is further described herein.

The cable retention and tensioning mechanism 100 can include a housing 102. As used herein, the term “housing” refers to an outer shell of a device. For example, the housing 102 can be an outer shell of the cable retention and tensioning mechanism 100. The housing 102 can include other components of the cable retention and tensioning mechanism 100, such as the carrier body 109, locking jaws 112, threaded tensioning rod 114, among other components as is further described herein.

The housing 102 can include an outer surface 103, an inner surface 104, a first end surface 105, and a second end surface 106. The inner surface 104 can define an opening partially through the housing 102. As used herein, the term “opening” refers to an aperture in material that defines a space within the material. For example, the opening 107 can be a space inside of the housing 102 that can be shaped to receive a carrier body 109, as is further described herein.

The first end surface 105 can include a cable opening 108. The cable opening 108 can be an opening through the first end surface 105 that creates a path between an area outside of the first end surface 105 and the opening 107 inside of the housing 102. The cable opening 108 can be sized so as to receive a cable and to allow the cable to be moved through the cable opening 108 and into the opening 107, as is further described herein.

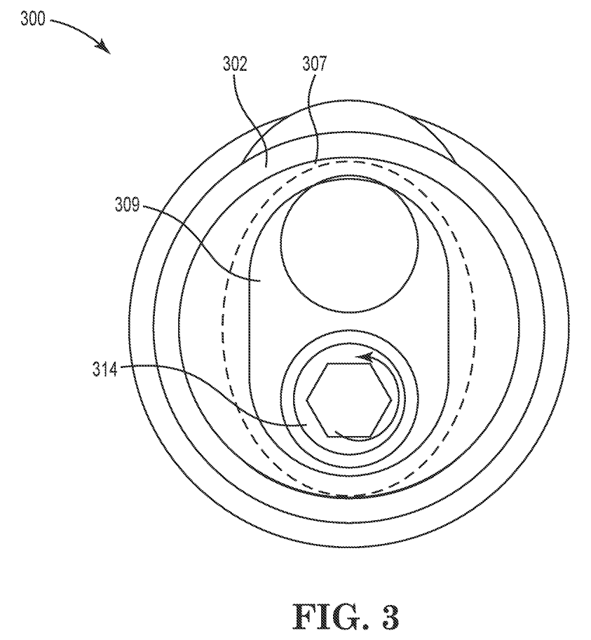

The cable retention and tensioning mechanism 100 can further include a carrier body 109. As used herein, the term “carrier body” refers to a structure that can enable the retention and tensioning of a cable. The carrier body 109 can be shaped so as to be received by the opening 107 of the housing 102. For example, as illustrated in FIG. 1 the cross-section of the carrier body 109 can have an oblong shape with rounded corners, and the opening 107 of the housing 102 can include a complimentary oblong with rounded corners cross-sectional shape in order to receive the carrier body 109 in the opening 107, as is further described in connection with FIG. 3.

The carrier body 109 can include an outer surface 130, a first end surface 132, and a second end surface 134. Accordingly, the first end surface 132 of the carrier body 109 can face (e.g., be oriented towards) the first end surface 105 of the housing 102 and the second end surface 134 of the carrier body 109 can face (e.g., be oriented towards) the second end surface 106 of the housing 102. The carrier body 109 can include a first opening 110 and a threaded second opening 111, as are further described herein.

The first opening 110 can be an opening through the carrier body 109. In some examples, the first opening 110 can include a tapered cross-section such that the cross-section of the first opening 110 gets larger going from the first end surface 132 of the carrier body 109 to the second end surface 134 of the carrier body 109. In other words, the cross-section of the first opening 110 is smaller near the first end surface 132 of the carrier body 109 and larger near the second end surface 134 of the carrier body 109. The first opening 110 can have a first axis 128-1.

Although examples described herein refer to the first opening 110 as a tapered first opening, embodiments of the disclosure are not so limited. For example, the first opening 110 can have any other cross-sectional profile, such as a constant cross-section the length of the first opening 110. In such an example, the first opening 110 may include a threaded opening that can receive a pre-assembled retention mechanism having a body including therein locking jaws, a spring seat, a spring, and a cap. In such a pre-assembled retention mechanism, the body can include a tapered opening so that the locking jaws in the pre-assembled retention mechanism function in the same manner as the locking jaws described herein.

As illustrated in FIG. 1, the first opening 110 is coaxially aligned with the cable opening 108. For example, the first opening 110 shares the same axis 128-1 as the cable opening 108. The coaxial location of the first opening 110 and the cable opening 108 can allow the locking jaws 112 to receive a cable through the cable opening 108 and the first opening 110, as is further described in connection with FIG. 3.

The threaded second opening 111 can be another opening through the carrier body 109. The threaded second opening 111 can include a constant cross-section through the carrier body 109. The threaded second opening 111 can include a threaded inner surface that is to interface with a threaded tensioning rod 114, as is further described herein. The second opening 111 can include a second axis 128-2.

As illustrated in FIG. 1, the first axis 128-1 and the second axis 128-2 can be offset from each other. For example, the first axis 128-1 and the second axis 128-2 are not coaxial. The first axis 128-1 and the second axis 128-2 can be offset from each other so as to isolate locking jaws 112 from rotation when a threaded tensioning rod 114 is rotated, as is further described herein. Isolation of the first axis 128-1 by offsetting the first opening 110 from the second opening 111 can prevent rotation of a cable when the locking jaws 112 are retaining a cable, as is further described herein.

As illustrated in FIG. 1, the first opening 110 and the second opening 111, and by extension the first axis 128-1 and the second axis 128-2, are substantially vertically offset from each other. However, embodiments of the disclosure are not so limited. For example, the first opening 110 and the second opening 111 can be offset from each other in any other direction (substantially horizontally, or between horizontally and vertically). As a result, the first axis 128-1 and the second axis 128-2 can also be offset from each other in any other direction.

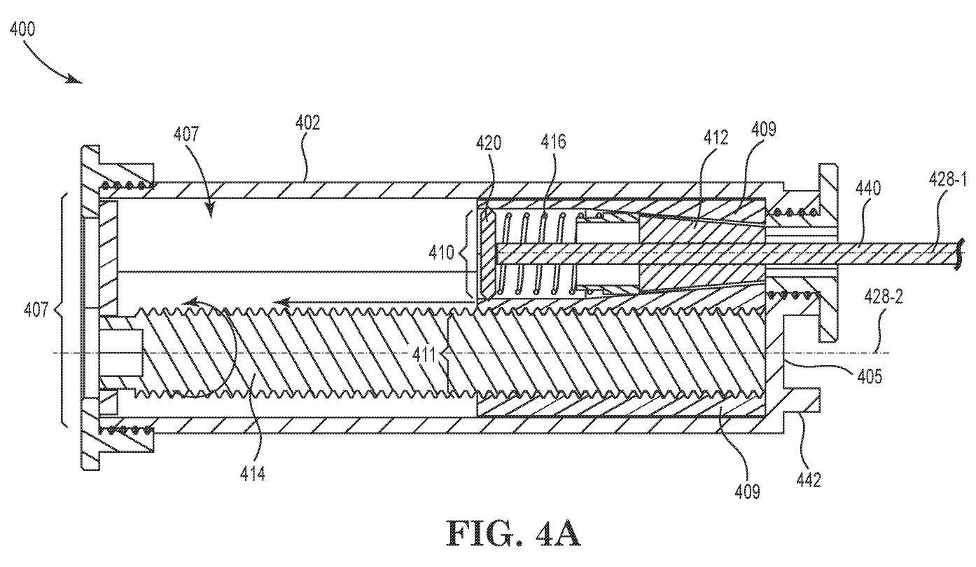

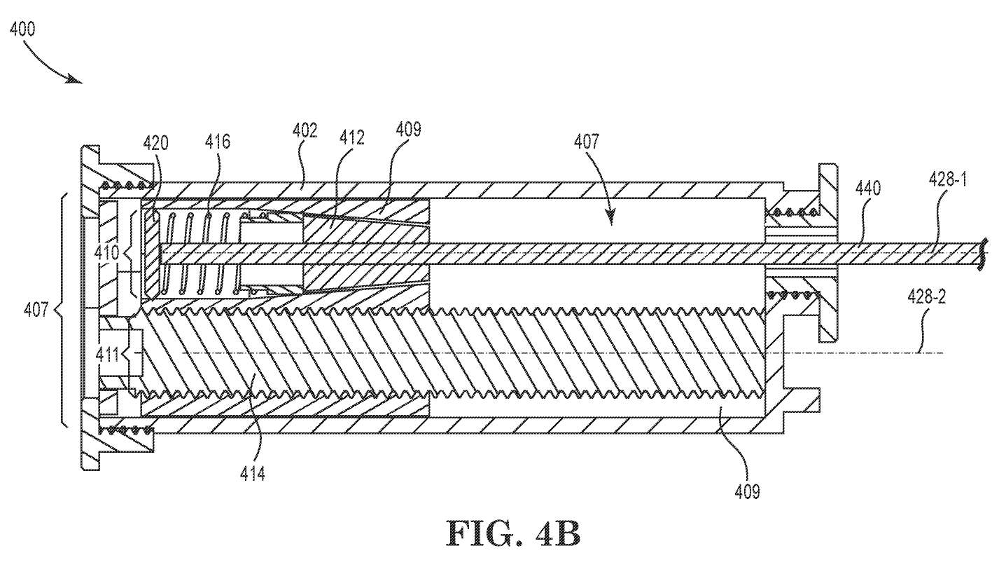

The cable retention and tensioning mechanism 100 can further include a threaded tensioning rod 114. The threaded tensioning rod 114 can be interfaced with the threaded inner surface of the threaded second opening 111. When rotated, the threaded tensioning rod 114 can cause the carrier body 109 to translate horizontally within the opening 107 inside of the housing 102, tensioning a cable as is further described in connection with FIGS. 4A-4B.

As mentioned above, the cable retention and tensioning mechanism 100 can further include locking jaws 112. As used herein, the term “locking jaws” refers to a device that grips another device. For example, the locking jaws 112 can retain a cable while the cable is being tensioned, as is further described herein.

The locking jaws 112 can be comprised of a first locking jaw and a second locking jaw, as is further described and illustrated in connection with FIG. 2B. The first locking jaw and the second locking jaw can radially expand (e.g., away from the axis 128-1) when the locking jaws 112 are horizontally translated in the first opening 110 (e.g., to the left as oriented in FIG. 1) and radially compress (e.g., towards the axis 128-1) when the locking jaws 112 are horizontally translated again in the first opening 110 (e.g., to the right as oriented in FIG. 1) to retain a cable, as is further described in connection with FIGS. 2A-2C.

The locking jaws 112 can be in the shape of a conical frustum. For example, the locking jaws 112 can be in the shape of a truncated cone having an opening through the locking jaws 112 that is aligned with the axis 128-1 (e.g., and as such is coaxial with the first opening 110 and the cable opening 108).

The carrier body 109 can further include a spring 116 located in the first opening 110. The spring 116 can bias the locking jaws 112 in a first position in the first opening 110. When receiving a cable, the cable can cause the locking jaws 112 to horizontally translate in the first opening 110 (e.g., which causes the locking jaws 112 to radially expand away from the axis 128-1 as previously mentioned above), also causing the spring 116 to translate horizontally and compress. When the cable slips into the opening between the locking jaws 112, the spring 116 horizontally translates the locking jaws 112 back towards the first position to cause the locking jaws 112 to clamp onto the cable to retain the cable. This process is further illustrated and described in connection with FIGS. 2A-2C.

As illustrated in FIG. 1, the spring 116 can be seated onto a spring seat 118. The spring 116 can be oriented around the spring seat 118 and can retain the spring 116 inside the first opening 110.

Additionally, the spring 116 can press against a cap 120. The cap 120 can bias the spring 116, keeping the spring 116, the spring seat 118, and the locking jaws 112 located inside of the first opening 110. The cap 120 can be connected to the first opening 110 proximate to the second end surface 134 of the carrier body 109.

Further, the cable retention and tensioning mechanism 100 can include a retention plate 122. Additionally, the retention plate 122 can include an opening 123 through the retention plate 122. The opening 123 of the retention plate 122 can be coaxially located with the threaded second opening 111. The opening 123 can allow for a tool to access the threaded tensioning rod 114 to rotate the threaded tensioning rod 114, as is further described in connection with FIGS. 4A-4B.

Lastly, the cable retention and tensioning mechanism 100 can include a retention cap 124. The retention cap 124 can bias the retention plate 122 and the threaded tensioning rod 114 inside of the cable retention and tensioning mechanism 100. The retention cap 124 can be connected to the housing 102 via a threaded connection, as illustrated in FIG. 1. However, embodiments are not so limited. The retention cap 124 can be connected to the housing 102 via any other means (e.g., adhesive, mechanical fit, interference fit, etc.).

FIG. 2A illustrates a side-section view of an example of a cable retention and tensioning mechanism 200 having locking jaws 212 in a first position in accordance with one or more embodiments. As illustrated in FIG. 2A, the cable retention and tensioning mechanism 200 has not received a cable.

As previously described in connection with FIG. 1, the cable retention and tensioning mechanism 200 can include a housing 202 having an opening 207 partially through the housing 202. The housing 202 can include a particular shape in order to receive a complimentarily shaped carrier body 209.

The carrier body 209 can include a first opening 210 through the carrier body 209 that is coaxially aligned with a cable opening of the housing 202. The first opening 210 can include a tapered cross-section and can include the spring 216 and the cap 220.

Additionally, the carrier body 209 can include the threaded second opening 211. As illustrated in FIG. 2A, the threaded second opening 211 can include a threaded inner surface that is engaged with the threaded tensioning rod 214.

As illustrated in FIG. 2A, the locking jaws 212 can be located in the first opening 210. The conical frustum shape of the locking jaws 212 can be a complementary shape to the first opening 210 such that the locking jaws 212 can fit into the first opening 210. Further, the spring 216 and the cap 220 can bias the locking jaws 212 to a first position as illustrated in FIG. 2A. When the locking jaws 212 are in the first position, the spring 216 can be in an extended (e.g., non-compressed) state.

The cable retention and tensioning mechanism 200 can receive a cable to retain and tension. For example, a cable can be received by the cable retention and tensioning mechanism 200 through the cable opening 208 of the housing 202 and can contact the locking jaws 212. The locking jaws 212 can be made up of two halves. For example, the locking jaws 212 can include a first locking jaw 238-1, comprising a first half of the conical frustum of the locking jaws 212, and a second locking jaw 238-2, comprising a second half of the conical frustum of the locking jaws 212. As a result of the cable pushing into the first opening 210, the locking jaws 212 can horizontally translate in a first direction (e.g., to the left, as oriented in FIG. 2A) inside the first opening 210 and the locking jaws 212 can radially expand inside the first opening 210 (e.g., the first locking jaw 238-1 and the second locking jaw 238-2 can radially expand away from the axis 228-1 due to the increasing cross-section of the first opening 210) until the cable is received by the locking jaws, as is further described in connection with FIG. 2B.

FIG. 2B illustrates a side-section view of an example of a cable retention and tensioning mechanism 200 having locking jaws 212 in a second position while receiving a cable 240 in accordance with one or more embodiments. As illustrated in FIG. 2B, the cable retention and tensioning mechanism 200 is in the process of receiving the cable 240.

As illustrated in FIG. 2B, the cable 240 is being received by the cable retention and tensioning mechanism 200. The cable 240 can be, for example, a stainless-steel cable used for a railing for a deck, although embodiments are not limited to a stainless steel cable.

As the cable 240 is received by the cable retention and tensioning mechanism 200, the cable 240 can provide a force on the locking jaws 212, causing the locking jaws 212 to horizontally translate in a first direction (e.g., left as oriented in FIG. 2B) inside the first opening 210 such that the locking jaws 212 have radially expanded inside the first opening 210. For example, due to the increasing cross-section of the first opening 210 as the locking jaws 212 move in the first direction (e.g., to the left as oriented in FIG. 2B), the first locking jaw 238-1 and the second locking jaw 238-2 can radially expand away from each other (e.g., and away from the axis 228-1). As the locking jaws 212 are horizontally translated to the second position, the cap 220 biases the spring 216 such that the spring 216 compresses against the cap 220 as the locking jaws 212 are horizontally translated by the cable 240 from the first position to the second position. When the locking jaws 212 are at the second position, as illustrated in FIG. 2B, the cable 240 can be positioned between the first locking jaw 238-1 and the second locking jaw 238-2 such that the cable 240 becomes located in the opening of the conical frustum of the locking jaws 212.

As mentioned above, the spring 216 can be compressed against the cap 220 due to the force provided by the cable 240 on the locking jaws 212. However, when the cable 240 becomes positioned between the first locking jaw 238-1 and the second locking jaw 238-2, the force provided by the cable 240 on the locking jaws 212 is no longer present. As such, the spring 216 can expand from the compressed state. The spring 216 can expand and provide a force on the spring seat 218. The expansion of the spring 216 from the compressed state can cause the locking jaws 212 to again horizontally translate within the first opening 210 back to the first position in order to retain the cable 240 as the locking jaws 212 radially contract, as is further described in connection with FIG. 2C.

FIG. 2C illustrates a side-section view of an example of a cable retention and tensioning mechanism 200 having locking jaws 212 in the first position while retaining a cable 240 in accordance with one or more embodiments. As illustrated in FIG. 2C, the cable retention and tensioning mechanism 200 has received and retained the cable 240.

For example, as illustrated in FIG. 2C, the spring 216 has decompressed as a result of the cable 240 no longer providing a compressive force. The absence of this compressive force by the cable 240 can cause the locking jaws 212 to horizontally translate in a second direction opposite the first direction (e.g., to the right, as oriented in FIG. 2C) back to the first position.

The horizontal translation of the locking jaws 212 in the second direction in the first opening 210 can cause the locking jaws 212 to clamp onto the cable 240 to retain the cable 240. For example, due to the decreasing cross-section of the first opening 210 as the locking jaws 212 move in the second direction (e.g., to the right, as oriented in FIG. 2C), the first locking jaw 238-1 and the second locking jaw 238-2 can radially contract towards each other (e.g., and towards the axis 228-1). In other words, the first opening 210 can force the locking jaws 212 towards the axis 228-1 such that the locking jaws 212 clamp down onto the cable 240.

In some examples, the locking jaws 212 can have an inner surface having a particular finish characteristic in order to promote the locking jaws 212 frictionally engaging with the cable 240. For example, the inner surface may be scored, may include friction treatments applied thereto, may include a friction promoting plating, among other examples.

As illustrated in FIG. 2C, the cable retention and tensioning mechanism 200 may include the retention cap 224. The retention cap 224 can bias the carrier body 209 including the locking jaws 212 and the threaded tensioning rod 214 in the housing 202.

Now that the cable retention and tensioning mechanism 200 has retained the cable 240, the cable retention and tensioning mechanism 200 can tension the cable 240. For example, the threaded tensioning rod 214 can be rotated in order to cause the carrier body 209 to translate in the opening 207 of the housing 202 in order to tension the cable 240, as is further described herein.

FIG. 3 illustrates a side-section view of an example of a threaded tensioning rod 314 being rotated while a carrier body 309 resists rotation located inside a housing 302 of a cable retention and tensioning mechanism 300 in accordance with one or more embodiments. As illustrated in FIG. 3, the threaded tensioning rod 314 can be rotated (e.g., counterclockwise, as oriented in FIG. 3). For example, a driver, such as a hex key, may be utilized to rotate the threaded tensioning rod 314. However, embodiments are not so limited. For example, the threaded tensioning rod 314 may include a differently shaped recess so that other drivers (e.g., a screwdriver) may be utilized to rotate the threaded tensioning rod 314.

While the threaded tensioning rod 314 is described above as being rotated counterclockwise, embodiments are not so limited. For instance, based on the threading of the threaded tensioning rod 314 and the threading in the threaded second opening (e.g., not illustrated in FIG. 3), the threaded tensioning rod 314 may be rotated clockwise in some examples.

As previously described in connection with FIG. 1, the carrier body 309 can be a particular shape and the opening 307 (e.g., indicated by the dashed line in FIG. 3) of the housing can be a complementary particular shape. For example, as illustrated in FIG. 1, the carrier body 309 can be an oblong shape having rounded corners, and the opening 307 of the housing can also be a complementary oblong shape having rounded corners.

Accordingly, the opening 307 and the carrier body 309 can be shaped such that when the threaded tensioning rod 314 is rotated, the shape of the opening 307 and the carrier body 309 substantially resists the carrier body 309 from rotating in the opening 307. Therefore, while the carrier body 309 and the opening 307 are described above as being complementarily oblong shaped, embodiments of the disclosure are not limited. For example, the carrier body 309 and the opening 307 can have rectangular shapes, square shapes, triangular shapes, or other irregular shapes that, when the threaded tensioning rod 314 is rotated, the shape of the opening 307 and the carrier body 309 prevents the carrier body 309 from rotating in the opening 307.

FIG. 4A illustrates a side-section view of an example of a cable retention and tensioning mechanism 400 having locking jaws 412 in the first position while retaining a cable 440 and the threaded tensioning rod 414 being rotated in accordance with one or more embodiments. As previously described in connection with FIGS. 2A-2C, the locking jaws 412 can retain the cable 440, and the threaded tensioning rod 414 can be rotated to tension the cable 440, as is further described herein.

As previously mentioned in connection with FIG. 1, the threaded tensioning rod 414 can include threads that can be interfaced with the threaded inner surface of the threaded second opening 411 of the carrier body 409. Accordingly, when the threaded tensioning rod 414 is rotated (e.g., as indicated in FIG. 4A), the interaction between the threads of the threaded tensioning rod 414 and the threaded inner surface of the threaded second opening 411 can cause the carrier body 409 to translate in a first direction along the threaded tensioning rod 414. For example, the carrier body 409 can translate in the first direction (e.g., left, as oriented in FIG. 4A) along the threaded tensioning rod 414 within the housing 402 in order to tension the cable 440.

As previously described in connection with FIG. 1, the first opening 410 can include the first axis 428-1 and the second opening 411 can include the second axis 428-2. The second axis 428-2 is offset from the first axis 428-1 so as to isolate the locking jaws 412 from rotation of the threaded tensioning rod 414. For example, as the threaded tensioning rod 414 is rotated in order to cause the carrier body 409 to translate in the first direction, due to the offset nature of the two axes 428-1, 428-2, rotation of the threaded tensioning rod 414 does not cause the locking jaws 412 (and by extension, the cable 440) to rotate.

For example, the center of rotation of the threaded tensioning rod 414 can be the second axis 428-2. That is, the threaded tensioning rod 414 can rotate about the second axis 428-2 when rotated. However, due to the distance offset between the second axis 428-2 and the first axis 428-1, the locking jaws 412 (and by extension, the cable 440) do not rotate about the second axis 428-2 when the threaded tensioning rod 414 is rotated. In other words, the center of rotation of the locking jaws 412 (and cable 440) is the first axis 428-1 and not the second axis 428-2. Accordingly, when the threaded tensioning rod 414 is rotated, the locking jaws 412 (and the cable 440) are mechanically isolated from the rotation of the threaded tensioning rod 414.

As illustrated in FIG. 4A, the first end surface 405 of the housing 402 can include a protrusion 442. When the cable retention and tensioning mechanism 400 is installed in a post, the protrusion 442 can interface with an opening in the post. Due to the protrusion 442 being interfaced with the opening in the post, the protrusion 442 can resist rotation of the cable retention and tensioning mechanism 400 when the threaded tensioning rod 414 is being rotated.

Although the housing 402 is illustrated in FIG. 4A and described above as including the protrusion 442, embodiments are not so limited. For example, the housing 402 may not include a protrusion 442. In an example in which the cable retention and tensioning mechanism 400 is utilized in a solid post, an opening can be created in the solid post (e.g., such as drilling into the solid post) such that the cable retention and tensioning mechanism 400 can be fit in the opening. As a result of the housing 402 being cylindrical, and the axis 428-2 being offset from the axis 428-1, the housing 402 is unable to be rotated in the opening of the solid post when the threaded tensioning rod 414 is being rotated due to the axis 428-2 creating a rotational diameter that is greater than the diameter of the opening (e.g., the drilled hole). In some additional examples, the cable retention and tensioning mechanism 400 can be fit in the opening via an interference fit. In addition to the axis 428-2 being offset from the axis 428-1 as described above, friction between the opening and the housing 402 can further can resist rotation of the cable retention and tensioning mechanism 400 (e.g., due to friction therebetween) when the threaded tensioning rod 414 is being rotated.

FIG. 4B illustrates a side-section view of an example of a cable retention and tensioning mechanism 400 having locking jaws 412 in the first position while retaining a cable 440 and the threaded tensioning rod 414 having caused a carrier body 409 to translate to tension the cable 440 in accordance with one or more embodiments. As illustrated in FIG. 4B, the carrier body 409 has been translated in the opening 407 of the housing 402 in the first direction (e.g., left, as oriented in FIG. 4A).

Due to the rotation of the threaded tensioning rod 414, the carrier body 409 has been translated in the opening 407 along the threaded tensioning rod 414. Therefore, the carrier body 409 translating in the first direction within the housing 402 can tension the cable 440.

Accordingly, a cable retention and tensioning mechanism 400, as described herein, can allow for a cable to be retained by locking jaws and then tensioned by rotating a threaded tensioning rod. As described above, the locking jaws can retain the cable 440 along a first axis 428-1, and the threaded tensioning rod can be rotated about a second axis 428-2. Utilizing different axes can allow for easy of installation and tensioning of a cable, as the different axes can allow for resistance to rotation of the cable retention and tensioning mechanism during tensioning of the cable. Accordingly, such a cable retention and tensioning mechanism can allow for easier, faster, and more efficient installation of cable railings, as compared with previous approaches.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A cable retention and tensioning mechanism, comprising:
a housing having an outer surface, an inner surface, a first end surface, and a second end surface opposite the first end surface, the inner surface defining an opening partially through the housing;
a carrier body shaped to be received by the opening partially through the housing, wherein the carrier body includes:
a first opening through the carrier body, the first opening having a first axis; and
a threaded second opening through the carrier body having a threaded inner surface interfaced with a threaded tensioning rod, the threaded second opening having a second axis, wherein the second axis is offset from the first axis;
locking jaws shaped to be received by the first opening through the carrier body; and
a retention cap configured to bias the carrier body including the locking jaws and the threaded tensioning rod in the housing;
wherein the locking jaws are configured to retain a cable and the threaded tensioning rod is configured to tension the cable.

2. The cable retention and tensioning mechanism of claim 1, wherein the first axis and the second axis are offset from each other so as to isolate the locking jaws from rotation of the threaded tensioning rod.

3. The cable retention and tensioning mechanism of claim 1, wherein the first end surface of the housing further includes a cable opening extending from the first end surface to the opening through the housing, wherein the cable opening is configured to receive the cable.

4. The cable retention and tensioning mechanism of claim 3, wherein the first opening of the carrier body is coaxially aligned with the cable opening such that the locking jaws are configured to receive the cable through the cable opening and the first opening.

5. The cable retention and tensioning mechanism of claim 3, wherein the locking jaws are configured to be horizontally translated by the cable from a first position in a first direction inside the first opening such that the locking jaws radially expand inside the first opening until the cable is received by the locking jaws at a second position.

6. The cable retention and tensioning mechanism of claim 5, wherein the carrier body further includes a spring in the first opening such that:
the spring is configured to bias the locking jaws in the first position in the first opening; and
the spring is configured to horizontally translate the locking jaws from the second position to the first position in a second direction to cause the locking jaws to clamp onto the cable to retain the cable in response to the locking jaws receiving the cable.

7. The cable retention and tensioning mechanism of claim 1, wherein in response to the locking jaws retaining the cable, the threaded tensioning rod is configured to be rotated to cause the carrier body to translate in a first direction along the threaded tensioning rod within the housing to tension the cable.

8. The cable retention and tensioning mechanism of claim 1, wherein the carrier body includes an outer surface, a first end surface, and a second end surface.

9. The cable retention and tensioning mechanism of claim 8, wherein the first end surface of the carrier body faces the first end surface of the housing.

10. The cable retention and tensioning mechanism of claim 8, wherein the second end surface of the carrier body faces the second end surface of the housing.

11. The cable retention and tensioning mechanism of claim 8, wherein the tapered cross-section of the first opening is tapered such that the tapered cross-section of the first opening gets larger from the first end surface of the carrier body towards the second end surface of the carrier body.

12. The cable retention and tensioning mechanism of claim 1, wherein the threaded tensioning rod, the carrier body, and the locking jaws are fully located inside the housing.

13. A cable retention and tensioning mechanism, comprising:
a housing having an outer surface, an inner surface, a first end surface, and a second end surface opposite the first end surface, wherein:
the inner surface defines an opening partially through the housing; and
the first end surface includes a cable opening extending from the first end surface to the opening through the housing;
a carrier body shaped to be received by the opening partially through the housing, wherein the carrier body includes:
a first opening through the carrier body coaxially aligned with the cable opening, wherein the first opening includes a spring and a cap and has a first axis; and
a threaded second opening through the carrier body having a threaded inner surface, the threaded second opening having a second axis, wherein the second axis is offset from the first axis;
locking jaws located in the first opening and biased to a first position by the spring and the cap, wherein:
the locking jaws are configured to be horizontally translated by a cable received through the cable opening and the first opening from the first position in a first direction inside the first opening such that the locking jaws radially expand inside the first opening until the cable is received by the locking jaws at a second position; and
the spring is configured to horizontally translate the locking jaws from the second position back to the first position in a second direction to cause the locking jaws to clamp onto the cable to retain the cable;
a threaded tensioning rod interfaced with the threaded inner surface of the threaded second opening, wherein the threaded tensioning rod is configured to be rotated to cause the carrier body to translate in a first direction along the threaded tensioning rod within the housing to tension the cable; and
a retention cap configured to bias the carrier body including the locking jaws and the threaded tensioning rod in the housing;
wherein the first axis and the second axis are offset from each other so as to isolate the locking jaws from rotation of the threaded tensioning rod.

14. The cable retention and tensioning mechanism of claim 13, wherein the opening partially through the housing and the carrier body are shaped such that the opening partially through the housing prevents the carrier body from rotating when the threaded tensioning rod is rotated.

15. The cable retention and tensioning mechanism of claim 14, wherein the carrier body is an oblong shape and the opening partially through the housing has a complementary oblong shape.

16. The cable retention and tensioning mechanism of claim 13, wherein:
the locking jaws are in a shape of a conical frustum having an opening therethrough and are comprised of a first locking jaw and a second locking jaw; and
the first locking jaw and the second locking jaw are configured to radially expand away from each other when the locking jaws are horizontally translated by the cable from the first position to the second position such that the cable becomes located in the opening of the conical frustum.

17. A cable retention and tensioning mechanism, comprising:
a housing having an outer surface, an inner surface, a first end surface, and a second end surface opposite the first end surface, wherein:
the inner surface defines an opening partially through the housing; and
the first end surface includes a cable opening extending from the first end surface to the opening through the housing;
a carrier body shaped to be received by the opening partially through the housing, wherein the carrier body includes:
a first opening through the carrier body coaxially aligned with the cable opening, wherein the first opening includes a spring and a cap and has a first axis; and
a threaded second opening through the carrier body having a threaded inner surface, the threaded second opening having a second axis, wherein the second axis is offset from the first axis;
locking jaws in a shape of a conical frustum and located in the first opening and biased to a first position by the spring and the cap, wherein:
the locking jaws are configured to be horizontally translated by a cable received through the cable opening and the first opening from the first position in a first direction inside the first opening such that the locking jaws radially expand inside the first opening until the cable is received by the locking jaws at a second position; and
the spring is configured to horizontally translate the locking jaws from the second position back to the first position in a second direction to cause the locking jaws to clamp onto the cable to retain the cable;
a threaded tensioning rod interfaced with the threaded inner surface of the threaded second opening, wherein the threaded tensioning rod is configured to be rotated to cause the carrier body to translate in a first direction along the threaded tensioning rod within the housing to tension the cable; and
a retention cap configured to bias the carrier body including the locking jaws and the threaded tensioning rod in the housing;
wherein the first axis and the second axis are offset from each other so as to isolate the locking jaws from rotation of the threaded tensioning rod.

18. The cable retention and tensioning mechanism of claim 17, wherein the cap biases the spring inside of the first opening such that the spring compresses against the cap as the locking jaws are horizontally translated by the cable from the first position to the second position.

19. The cable retention and tensioning mechanism of claim 17, further comprising a retention plate having an opening therethrough, wherein the opening of the retention plate is coaxially located with the threaded second opening through the carrier body.

20. The cable retention and tensioning mechanism of claim 17, wherein the first end surface comprises a protrusion configured to interface with an opening in a post to prevent the housing from rotating when the threaded tension rod is rotated.
